(19) United States
(12) Patent Application Publication
(10) Pub. No.: US 2014/0074972 A1
(43) Pub. Date: Mar. 13, 2014

(54) System and Electronic Device

(71) Applicant: Kabushiki Kaisha Toshiba, Tokyo (JP)

(72) Inventor: Yuuichi Togashi, Tokyo (JP)

(73) Assignee: Kabushiki Kaisha Toshiba, Tokyo (JP)

(21) Appl. No.: 13/968,160

(22) Filed: Aug. 15, 2013

Related U.S. Application Data
(63) Continuation of application No. PCT/JP2013/057928, filed on Mar. 13, 2013.

(30) Foreign Application Priority Data
Sep. 7, 2012 (JP) 2012-197891

(51) Int. Cl. H04L 29/08

(52) U.S. Cl. CPC H04L 67/06
USPC 709/217

(57) ABSTRACT

According to one embodiment, a system is configured to be for providing a service for exchanging or sharing information between linked accounts. The system transmits a first code to a first electronic device in response to a request for a code from the first electronic device, the first code being associated with an account of the first electronic device and being displayable on a display of the first electronic device. The system links the account of the first electronic device and an account of a second electronic device to which the first code is inputtable by a user, after receiving first information generated by using the first code from the second electronic device.

### CROSS-REFERENCE TO RELATED APPLICATIONS

This application is a Continuation Application of PCT Application No. PCT/JP2013/057928, filed Mar. 13, 2013 and based upon and claiming the benefit of priority from Japanese Patent Application No. 2012-197891, filed Sep. 7, 2012, the entire contents of all of which are incorporated herein by reference.

### FIELD

Embodiments described herein relate generally to a technique for linking electronic devices.

### BACKGROUND

In recent years, digital TVs including network communication functions have been gaining in popularity. This kind of digital TV is able to not only receive and play back broadcast content, but also receive various kinds of information from various sites on the Internet.

However, in the present situation, the above-described network communication functions are scarcely used for, for example, exchanging information between digital TVs (DTVs) which are geographically distant from each other. In addition, electronic devices, such as DTVs, are required to have such good user-friendliness that even children and the elderly can easily operate such devices.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view for describing the outline of a system according to an embodiment;

FIG. 2 is an exemplary block diagram illustrating a configuration of the system of the embodiment;

FIG. 3 is an exemplary block diagram illustrating a configuration of an account server in the system of the embodiment;

FIG. 4 is an exemplary block diagram illustrating a configuration of an electronic device (TV) which is linked to the system of the embodiment;

FIG. 5 is an exemplary block diagram illustrating another configuration of the electronic device (TV) which is linked to the system of the embodiment;

FIG. 6 is an exemplary block diagram illustrating a menu screen which is displayed on the electronic device (TV) that is linked to the system of the embodiment;

FIG. 7 is an exemplary block diagram illustrating another menu screen which is displayed on the electronic device (TV) that is linked to the system of the embodiment;

FIG. 8 is an exemplary view for describing a process for logging in to the system of the embodiment;

FIG. 9 is an exemplary view for describing a process of creating an account of a new user in the system of the embodiment;

FIG. 10 is an exemplary view for describing another process of creating an account of a new user in the system of the embodiment;

FIG. 11 is an exemplary view for describing a process of editing a profile of a certain account which is managed by the system of the embodiment;

FIG. 12 is an exemplary view for describing a process of deleting a certain user account which is managed by the system of the embodiment;

FIG. 13 is an exemplary view for describing a process of creating a user account corresponding to an electronic device (TV) which is linked to the system of the embodiment, by using an existing user account;

FIG. 14 is an exemplary view for describing a part of a process for linking accounts which are managed by the system of the embodiment;

FIG. 15 is an exemplary view for describing the other part of the process for linking accounts which are managed by the system of the embodiment;

FIG. 16 is an exemplary view for describing a part of another process for linking accounts which are managed by the system of the embodiment;

FIG. 17 is an exemplary view for describing the other part of the another process for linking accounts which are managed by the system of the embodiment;

FIG. 18 is an exemplary view illustrating a procedure of communication for linkage between accounts, which is executed between the system of the embodiment and two electronic devices (TVs);

FIG. 19 is an exemplary flowchart illustrating a procedure of a linkage process which is executed by the system of the embodiment;

FIG. 20 is an exemplary view illustrating a device management table which is used by the system of the embodiment;

FIG. 21 is an exemplary view illustrating a linkage management table which is used by the system of the embodiment;

FIG. 22 is an exemplary flowchart illustrating a procedure of a process which is executed by an electronic device (TV) that is linked to the system of the embodiment; and

FIG. 23 is an exemplary flowchart illustrating a procedure of a process which is executed by another electronic device (TV) that is linked to the system of the embodiment.

### DETAILED DESCRIPTION

Various embodiments will be described hereinafter with reference to the accompanying drawings.

In general, according to one embodiment, a system is configured to be for providing a service for exchanging or sharing information between linked accounts. Pluralities of accounts correspond to a plurality of electronic devices. The system includes a first transmitter and a linkage module. The first transmitter is configured to transmit a first code to a first electronic device in response to a request for a code from the first electronic device, the first code being associated with an account of the first electronic device and being displayable on a display of the first electronic device. The linkage module is configured to link the account of the first electronic device and an account of a second electronic device to which the first code is inputtable by a user, after receiving first information generated by using the first code from the second electronic device.

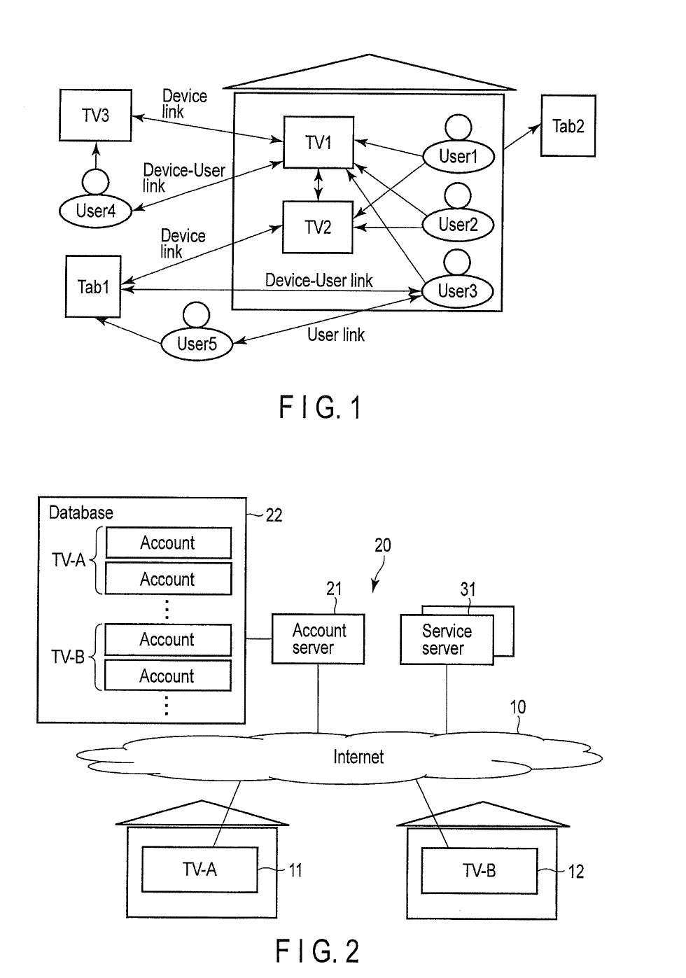

FIG. 1 illustrates the outline of a system according to an embodiment. This system may manage accounts of a plurality of electronic devices. The electronic devices are, for instance, TVs (digital TVs), tablet terminals, notebook-type personal computers, etc.

In addition, this system may provide a service for linking the accounts of the plural electronic devices, and sharing or exchanging information between the linked accounts. The linkage between the accounts of electronic devices may be any kind of process which can execute a service for sharing or exchanging information between the accounts of electronic devices, for example, a process of registering information, which relates to linkage, in a server or in at least one of electronic devices.

This system can link, for example, TVs in a home. Further, this system can link each TV in the home to a TV outside the home, for instance, a TV in the home of a friend, a TV in the home of a relative, etc. Moreover, this system can link each TV in the home to a tablet terminal outside the home, for instance, a tablet terminal possessed by a friend. In FIG. 1, a TV (TV1) in the home is linked to another TV (TV2) in the home, and is also linked to a TV3 outside the home. In addition, the TV (TV2) is linked to a tablet terminal (Tab1) outside the home.

Besides, this system can manage one or more users (user accounts) for each electronic device. FIG. 1 illustrates the case in which three user accounts (User1, User2, User3) are managed by the system as user accounts corresponding to the TV1 and two user accounts (User1, User2) are managed by the system as user accounts of to the TV2. Each of the user accounts User1, User2 and User3 is an account for logging in to the system by using the TV1. In addition, each of the user accounts User1 and User2 can also log in to the system by using the TV2.

Furthermore, this system can link a user account corresponding to a certain electronic device to an arbitrary electronic device, and can link a certain user account and another user account. In FIG. 1, for example, the user account User3 is linked to the tablet terminal (Tab1). In addition, the user account User3 is also linked to User5 which is a user account that can log in to the system by using the tablet terminal (Tab1).

FIG. 2 illustrates a configuration of a system 20 of the embodiment. The system 20 is realized by one or more servers which are connected to the Internet 10. FIG. 2 illustrates the case in which the system 20 is realized by an account server 21 and a plurality of service servers 31. The configuration of the system 20 is not limited to this, and, for example, the function of the account server 21 and the function of a certain service server 31 may be realized by one physical server.

The account server 21 manages a plurality of accounts which correspond to a plurality of electronic devices, respectively, which are connectable to the Internet 10. These accounts are used for identifying an electronic device which logs in to the system 20 or a user which logs in to the system 20. These accounts are stored in a database 22. Each electronic device includes a client function (cloud client function) for linkage to the system 20. By using the cloud client function, each electronic device can log in to the system 20, and can also obtain various services provided from the system 20.

Each service server 31 can provide various services to the electronic device which has logged in to the system 20. A certain service server 31 can execute a service for exchanging or sharing information between accounts which are mutually linked by the account server 21. In other words, a service is executed for exchanging or sharing information between electronic devices which are mutually linked, between an electronic device and a user which are mutually linked, or users which are mutually linked.

The case is now assumed that an account corresponding to a TV (TV-A) 11 in a certain home is linked to an account corresponding to a TV (TV-B) 12 in another home. By logging in to the system 20, the TV (TV-A) 11 can acquire various information relating to the TV (TV-B) 12 from the system 20. For example, the TV (TV-A) 11 can acquire from the system 20 information indicative of a program (TV program), the recording/viewing of which is preset by the TV (TV-B) 12, or schedule information of the user of the TV (TV-B) 12. Further, the TV (TV-A) 11 can also transmit and receive various information, such as messages, to and from the TV (TV-B) 12 via the system 20 (message exchange).

The case is now assumed that each of the TV (TV-A) 11 and TV (TV-B) 12 has logged in to the system 20. Each of the communication between the system 20 and the TV (TV-A) 11 and the communication between the system 20 and the TV (TV-B) 12 may be executed by using, e.g. HTTP. Each of the TV (TV-A) 11 and the TV (TV-B) 12 may function as a Web client, and the system 20 may function as a Web server. The TV (TV-A) 11 transmits to the system 20 a message including an identifier (e.g. device ID) of the TV (TV-B) 12 and transmission data, that is, a message addressed to the TV (TV-B) 12. The TV (TV-B) 12 transmits to the system 20, for example, a request for acquisition of a message addressed to the TV (TV-B) 12. Responding to reception of this message acquisition request, the system 20 transmits to the TV (TV-B) 12 the above-described message which has been received from the TV (TV-A) 11.

The account server 22 can manage one or more accounts as accounts corresponding to the TV (TV-A) 11. The kinds of account, which can be managed by the account server 22, include a device account and a user account.

The device account is an account which is shared between users that use the TV (TV-A) 11, that is, a family account (family ID). An identifier that is unique to the TV (TV-A) 11, for instance, a device ID, can be managed by the system 20 as the device account of the TV (TV-A) 11.

When the above-described cloud client function of the TV (TV-A) 11 has been called by an operation of a remote control unit by a user, a cloud client program in the TV (TV-A) 11 is activated. This cloud client program can automatically log in to the system 20 by using the device account (e.g. device ID of TV (TV-A) 11) of the TV (TV-A) 11. In this embodiment, the state of login to the system 20 with use of the device account is called State 2.

Further, in the present embodiment, the user of the TV (TV-A) 11 can also log in to the system 20 by using the user account corresponding to the TV (TV-A) 11. In the case where a plurality of user accounts corresponding to the TV (TV-A) 11 are managed by the system 20, the user selects an arbitrary user account from the plural user accounts corresponding to the TV (TV-A) 11, and inputs an identification code corresponding to the selected user account, for instance, a PIN. The account server 21 checks whether the input identification code (PIN) is correct or not, that is, whether the input PIN agrees with the PIN corresponding to the selected user account. If the input PIN is correct, login to the system 20 with use of the selected user account is permitted. In this embodiment, the state of login to the system 20 with use of the user account is called State 3.

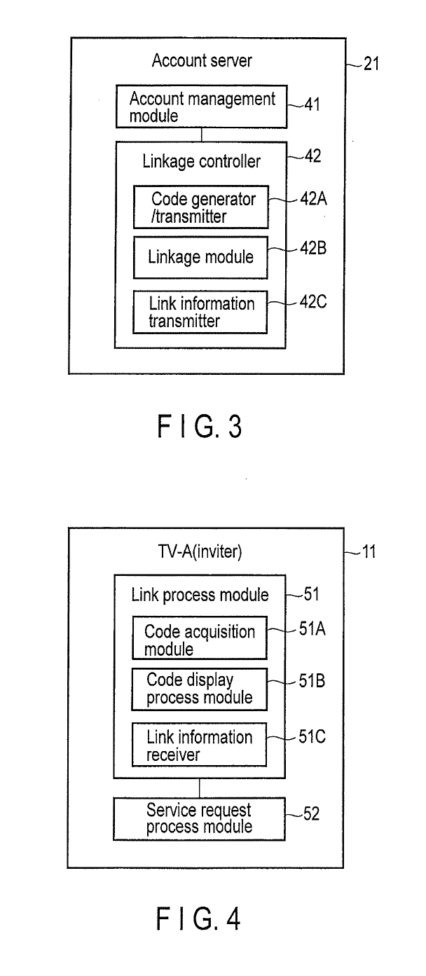

FIG. 3 illustrates a configuration of the account server 21.

The account server 21 includes an account management module 41 and a linkage controller 42. The account management module 41 manages a plurality of accounts corresponding to a plurality of electronic devices (TV, tablet, etc.) which are connectable to the system 20. The linkage controller 42 executes a process for linking an electronic device in a certain home to an electronic device outside the home. The linkage controller 42 includes a code generator/transmitter 42A, a linkage module 42B and a link information transmitter 42C.

Responding to a request for a code from a certain electronic device (first electronic device), the code generator/transmitter 42A generates a first code which is associated with the account of the first electronic device and is displayable on the display of the first electronic device. This first code is called “invitation code”. A time-limit code with a term of validity is usable as the first code, or a first invitation code. The term of validity of the first invitation code is, e.g. 48 hours. The first invitation code is composed of, for example, an 8-digit numeral string. The first invitation code is stored in the account server 21 in the state in which the first invitation code is associated with the account of the first electronic device, for example, in the state in which the first invitation code is associated with the identifier, such as the device ID, of the first electronic device. By adding the term of validity to the first invitation code, the risk of unlawful use of the first invitation code can be lowered.

The code generator/transmitter 42A transmits the first invitation code to the first electronic device. Since the first invitation code is a displayable code, the first invitation code is displayed on the display of the first electronic device. Thus, since the user can learn the first invitation code (8-digit number), this user can inform the user of another electronic device (second electronic device), which is to be linked to the first electronic device, of the first invitation code (8-digit number). The user of the first electronic device can inform the user of the second electronic device of the first invitation code (8-digit number), for example, by making a telephone call to the user of the second electronic device or by sending an email to the user of the second electronic device. By operating a remote control unit, the user of the second electronic device can input the notified first invitation code to an input screen which is displayed on the display of the second electronic device. As described above, since the first invitation code is a simple code comprising only the 8-digit number, the user of the second electronic device can easily input the first invitation code to the input screen displayed on the display of the second electronic device, by operating the remote control unit. The cloud client program of the second electronic device transmits the code (first invitation code), which has been input to the second electronic device by the user, to the system 20.

The linkage module 42B links the account of the first electronic device and the account of the second electronic device, after receiving the above-described first invitation code from the second electronic device. In this case, for example, information, which indicates that the account of the first electronic device and the account of the second electronic device are mutually linked accounts, is registered in the database 22.

The link information transmitter 42C transmits first link information indicative of the account of the second electronic device, which is linked to the account of the first electronic device, to the first electronic device. For example, when the link information transmitter 42C has received a link information request from the first electronic device, the link information transmitter 42C may transmit the above-described first link information to the first electronic device.

In addition, the link information transmitter 42C transmits second link information indicative of the account of the first electronic device, which is linked to the account of the second electronic device, to the second electronic device. For example, when the link information transmitter 42C has received a link information request from the second electronic device, the link information transmitter 42C may transmit the above-described second link information to the second electronic device.

In the meantime, the information that is to be transmitted from the second electronic device to the account server 21 may not be the first invitation code itself. For example, certain information (first information), which is generated from the first invitation code, may be transmitted from the second electronic device to the account server 21. In this case, after receiving the above-described first information from the second electronic device, the linkage module 42B links the account of the first electronic device and the account of the second electronic device.

FIG. 4 illustrates a configuration of the TV (TV-A) 11. The case is assumed that the TV (TV-A) 11 functions as a device which requests acquisition of the above-described first invitation code, that is, a device (inviter) which invites another electronic device or another user.

The TV (TV-A) 11 includes a link process module 51 and a service request process module 52. The link process module 51 executes a client process for linking the account of the TV (TV-A) 11 to another arbitrary account. The link process module 51 includes a code acquisition module 51A, a code display process module 51B and a link information receiver 51C.

The code acquisition module 51A transmits a code request to the system 20 (account server 21), thereby acquiring from the system 20 (account server 21) a first invitation code which is associated with the account of the TV (TV-A) 11. The code display process module 51B displays the first invitation code on the display of the TV (TV-A) 11, thereby presenting the first invitation code to the user.

The link information receiver 51C receives from the system 20 (account server 21) link information indicative of the account of another electric device. This account of another electric device is an account which is linked to the account of the TV (TV-A) 11 by the system 20 (account server 21) based on the first invitation code.

The service request process module 52 can request the system 20 to execute a service for exchanging or sharing information between the account of the TV (TV-A) 11 and the account of each of other electronic devices which are linked to the account of the TV (TV-A) 11. In addition, based on the received link information, the service request process module 52 can display on the display of the TV (TV-A) 11 a list of the accounts of other electronic devices which are linked to the account of the TV (TV-A) 11. The user can select an arbitrary account, which is to be a communication target, from this list of accounts.

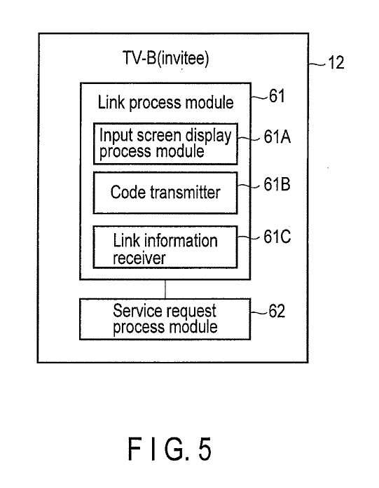

FIG. 5 illustrates a configuration of the TV (TV-B) 12. The case is assumed that the TV (TV-B) 12 functions as a device which transmits to the system 20 a code that has been input by the user, that is, a device (invitee) which is invited by another electronic device or another user.

The TV (TV-B) 12 includes a link process module 61 and a service request process module 62. The link process module 61 executes a client process for linking the account of the TV (TV-B) 12 to the account of an inviter. The link process module 61 includes an input screen display process module 61A, a code transmitter 61B and a link information receiver 61C.

The input screen display process module 61A causes the display of the TV (TV-B) 12 to display an input screen for prompting the user to input a displayable code (e.g. the above-described first invitation code) which is associated with the account of another electronic device. The code transmitter 61B transmits to the system 20 the code (e.g. the above-described first invitation code) which has been input to the input screen. In the meantime, as described above, the information that is to be transmitted to the account server 21 is not limited to the first invitation code itself, and the first information, which is generated from the first invitation code, may be transmitted to the system 20.

The link information receiver 61C receives from the system 20 the link information indicative of the account of another electric device which is linked to the account of the TV (TV-B) 12 by the system 20 based on the transmitted code (e.g. the above-described first invitation code).

The service request process module 62 can request the system 20 to execute a service for exchanging or sharing information between the account of the TV (TV-B) 12 and the account of each of other electronic devices which are linked to the account of the TV (TV-B) 12. In addition, based on the received link information, the service request process module 62 can display on the display of the TV (TV-B) 12 a list of the accounts of other electronic devices which are linked to the account of the TV (TV-B) 12. The user of the TV (TV-B) 12 can select an arbitrary account, which is to be a communication target, from this list of accounts.

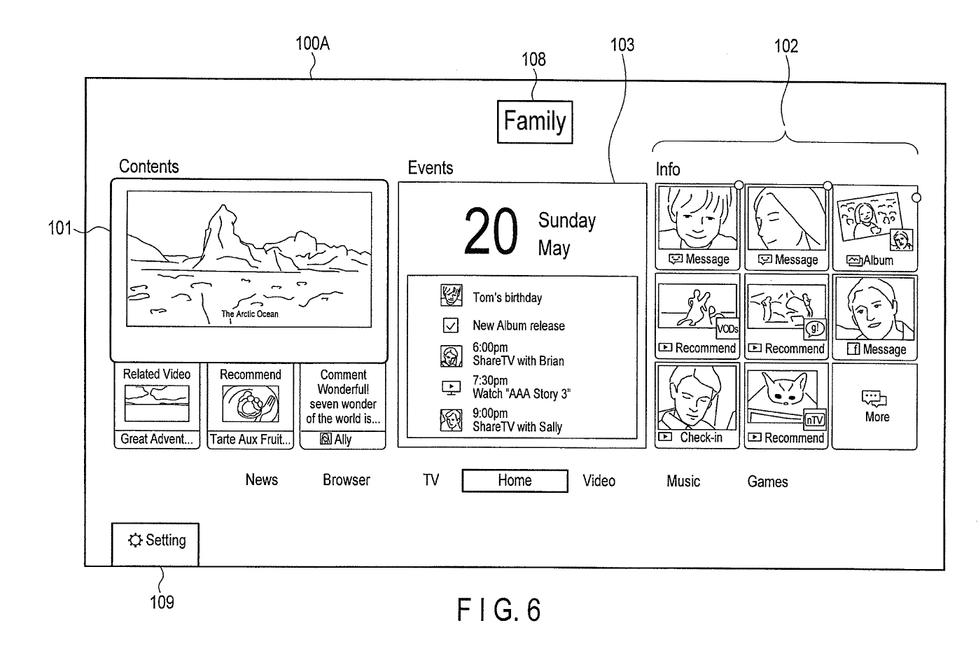

FIG. 6 illustrates a menu screen 100A which is displayed on each electronic device that is linked to the system 20. The menu screen 100A is a menu screen corresponding to State 2, and is displayed when the electronic device has logged in to the system 20 by using the device account (family ID).

The menu screen 100A includes display areas 101, 102 and 103. In addition, the menu screen 100A displays a login/logout button 108 and a setting button 109.

The display area 101 displays images of various contents such as a TV program which is currently being broadcast. The display area 102 is an area for displaying, e.g. messages/recommend data which are received from another account that is linked to the device account (family ID) of this electronic device. For example, messages/recommend data from family members and friends are displayed in the display area 102. Examples of the recommend data include recommend program information and recommend shopping information.

The display area 103 is an area for displaying calendar information. The display area 103 displays today's schedules of respective users registered in this electronic device, programs the recording/viewing which is preset, and other various information.

Taking the above-described calendar information as an example, a description is given of how information is shared or exchanged between linked accounts.

(1) Acquisition of a Third Person's Calendar (e.g. Preset Viewing, Preset Recording, or a Schedule of Actions)

An electronic device can acquire, from the system 20, calendar information of an account (user himself/herself) of the electronic device that is currently logging in to the system 20, and calendar information of another account (third person) which is linked to this account of the electronic device that is logging in to the system 20. The calendar information corresponding to each account is managed by the system 20. The calendar information includes a schedule of actions (e.g. a schedule of shopping, or a schedule of outing), preset viewing (automatic channel switching to “xxx program” (“xx channel”) at “xx day/xx hour”), and preset recording (preset recording of a predetermined program).

However, the range of publication of the schedule of actions, preset viewing and preset recording can be set on an account-by-account basis. Depending on the setting of the range of publication, there is a case that each electronic device cannot acquire calendar information of even an account which is linked to the account of this electronic device itself.

(2) Import of a Third Person's Presetting of Viewing/Recording

Based on the preset viewing information and preset recording information included in the calendar information of another account (third person), preset viewing and preset recording corresponding to the account of the user himself/herself that is logging in can be performed.

(3) Synchro-Viewing

A function of enabling simultaneous viewing (synchro-viewing) of the same program (on-air program, recorded program, VOD, etc.) as a third person views can be realized. Another account (third person), which is linked to the account (user himself/herself) that is logging in, can be invited to view an “xxx” program from a time (“xx” day/“xx” hour). Invitations to synchro-viewing can be issued at a time to a plurality of other accounts (third persons). In addition, an invitation to synchro-viewing can be issued to an arbitrary one selected from a plurality of other accounts (third persons).

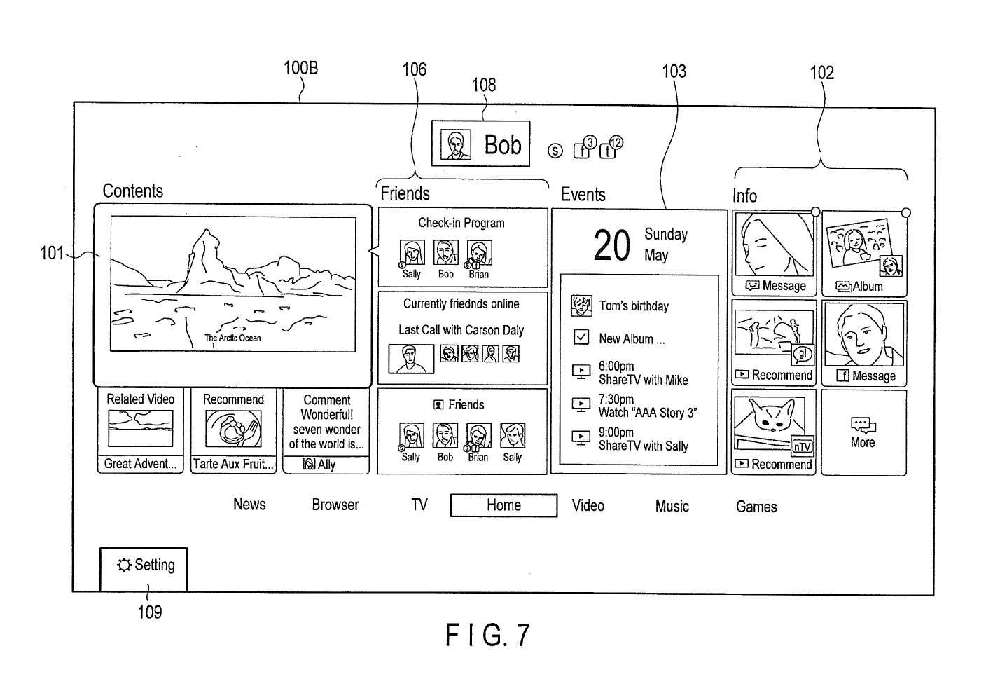

FIG. 7 illustrates a menu screen 100B which is displayed on each electronic device that is linked to the system 20. The menu screen 100B is a menu screen corresponding to State 3, and is displayed when the electronic device has logged in to the system 20 by using a user account (user ID). The case is assumed that the electronic device has logged in to the system by using a user account “Bob”.

The display area 102 displays, e.g. messages/recommend data addressed to the user (“Bob”) that is currently logging in. In addition, the display area 103 displays calendar information of the user (“Bob”), and calendar information of other users that are linked to this user (“Bob”). The menu screen 100B further includes a display area 106.

The display area 106 displays information (“Check-in to Program”, “Currently friends online”, “Friends”) relating to communications with other users (friends) that are linked to the user (“Bob”) that is currently logging in. The “Check-in to Program” displays a list of other users (friends) that are simultaneously viewing the same program as the user (“Bob”) that is currently logging in. The “Currently friends online” displays a list of other users (friends) that are viewing programs which are different from the program that the user (“Bob”) that is currently logging in is viewing. The “Friends” displays a list of friends of the user (“Bob”) that is currently logging

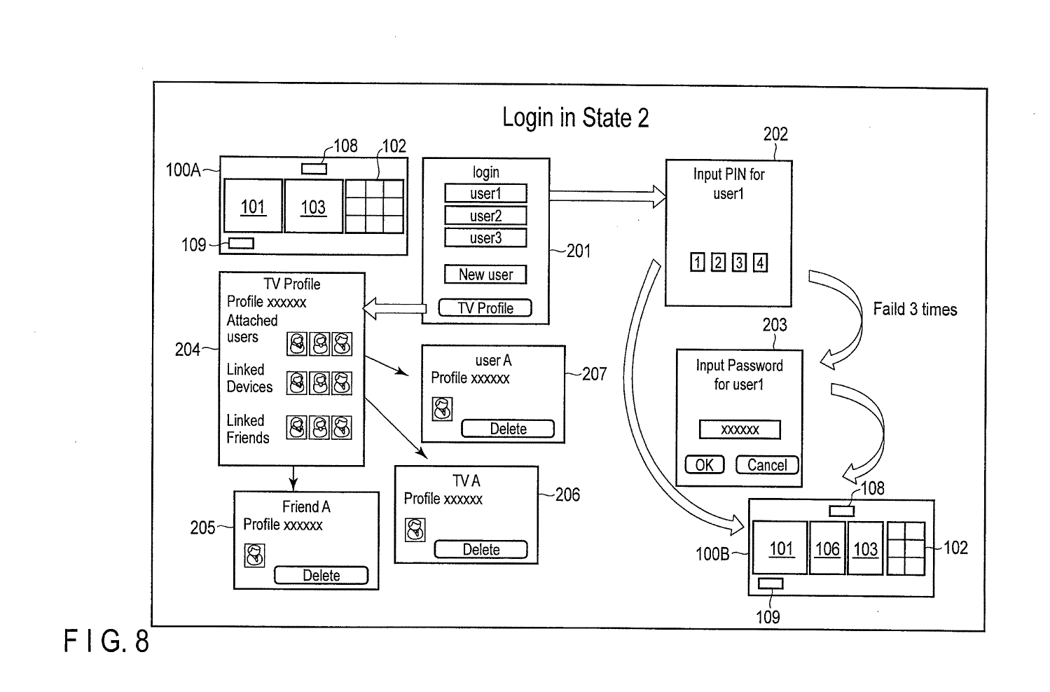

FIG. 8 illustrates the procedure of a login process for logging in to the system 20. The case is assumed that the TV (TV-A) 11 logs in to the system 20 by using a certain user account which is associated with the device account of this TV (TV-A) 11. If the user presses the login/logout button 108 on the menu screen 100A, the TV (TV-A) 11 displays a login screen 201, based on login screen data which is received from the system 20. The login screen 201 displays buttons (“user1” button, “user2” button, “user3” button) indicative of users that are registered as users of the TV (TV-A) 11, that is, buttons (“user1” button, “user2” button, “user3” button) indicative of user names of user accounts which are associated with the device account of the TV (TV-A) 11. The login screen 201 further displays a “New user” button for creating a new user that is associated with the device account of the TV (TV-A) 11, and a “TV Profile” button for displaying or editing the profile of the TV (TV-A) 11.

When the “user1” button has been selected by the user, the TV (TV-A) 11 displays a user ID input screen 202, based on user ID input screen data which is received from the system 20. The user ID input screen 202 is a screen for prompting the user to input a user ID (PIN) of the selected user “user1”. The user ID is expressed by, for example, a 4-digit numeral string. If the user presses, for example, an “Enter” button of a remote control unit in the state in which the user ID is input to the user ID input screen 202, the TV (TV-A) 11 transmits the user name “user1” of the selected user and the input user ID to the system 20 (account server 21). The account server 21 determines whether the input user ID is correct or not, that is, whether the input user ID agrees with the user ID of the selected user “user1”. If the input user ID is correct, the account server 21 permits the TV (TV-A) 11 to log in to the system 20 by using the user name “user1”. Then, the login state of the TV (TV-A) 11 is changed from State 2 to State 3. The system 20 generates menu screen data corresponds to the “user1” that has logged in, and transmits this menu screen data to the TV (TV-A) 11. Based on the menu screen data, the TV (TV-A) 11 displays the menu screen 100B corresponding to the “user1”.

If verification of the input user ID (PIN) has failed a predetermined number of times, for example, three times, the account server 21 transmits password input screen data to the TV (TV-A) 11 in order to relieve the user from the failure in the login operation. Based on the password input screen data, the TV (TV-A) 11 displays a password input screen 203 for prompting the user to input a password corresponding to the selected user “user1”. If an “OK” button on the password input screen 203 is pressed in the state in which the password is input to the password input screen 203, the TV (TV-A) 11 transmits the user name “user1” of the selected user and the input password to the system 20 (account server 21). The account server 21 determines whether the input password is correct or not, that is, whether the input password agrees with the password of the selected user “user1”. If the password is correct, the account server 21 permits the TV (TV-A) 11 to log in to the system 20 by using the user name “user1”.

If the “TV profile” button on the login screen 201 is pressed by the user, the TV (TV-A) 11 displays a TV profile screen 204, based on TV profile screen data which is received from the system 20. The TV profile screen 204 displays “Attached Users”, “Linked Devices” and “Linked Friends”. The “Attached Users” displays a list of users that are registered as users of the TV (TV-A) 11, that is, a list of user accounts which are associated with the device account of the TV (TV-A) 11. The “Linked Devices” displays a list of device accounts of other devices which are linked to the device account of the TV (TV-A) 11. The “Linked Friends” displays a list of other user accounts which are linked to the device account of the TV (TV-A) 11, that is, a list of friends.

If a certain user (friend) on the “Linked Friends” is selected by the user of the TV (TV-A) 11 (in this example, the case is assumed that user A (friend A) is selected), the TV (TV-A) 11 displays a profile screen 205 which enables editing of the profile of the friend A, based on profile screen data corresponding to the friend A which is received from the system 20. The profile screen 205 displays information indicative of the profile of the friend A, and also displays a “Delete” button. The “Delete” button is an operation button for deleting the friend A from the “Linked Friends” of the TV (TV-A) 11.

If a certain device on the “Linked Devices” is selected by the user of the TV (TV-A) 11 (in this example, the case is assumed that a TV A is selected), the TV (TV-A) 11 displays a profile screen 206 which enables editing of the profile of the TV A, based on profile screen data corresponding to the TV A which is received from the system 20. The profile screen 206 displays information indicative of the profile of the TV A, and also displays a “Delete” button. The “Delete” button is an operation button for deleting the TV A from the “Linked Devices” of the TV (TV-A) 11.

If a certain user on the “Attached Users” is selected by the user of the TV (TV-A) 11 (in this example, the case is assumed that user A is selected), the TV (TV-A) 11 displays a profile screen 207 which enables editing of the profile of the user A, based on profile screen data corresponding to the user A which is received from the system 20. The profile screen 207 displays information indicative of the profile of the user A, and also displays a “Delete” button. The “Delete” button is an operation button for deleting the user A from the “Attached Users” of the TV (TV-A) 11.

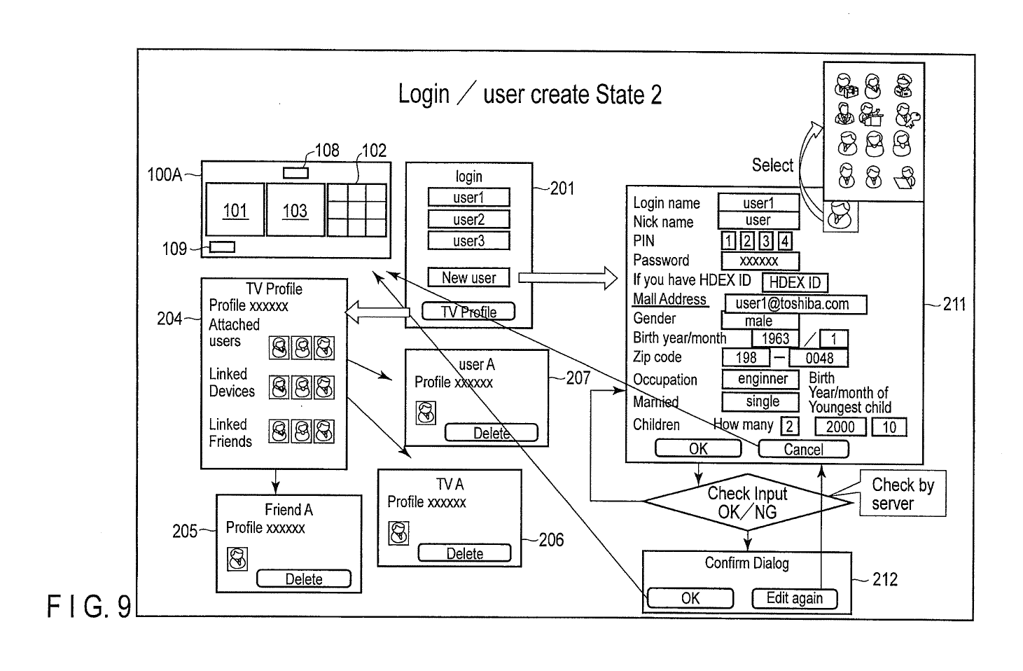

FIG. 9 illustrates a process procedure which is executed when the “New user” button on the login screen 201 has been pressed. The TV (TV-A) 11 displays a user account creation screen 211, based on user account creation screen data which is received from the system 20. The user account creation screen 211 includes a plurality of input fields for inputting various kinds of information corresponding to a user account which is to be newly created. The various kinds of information corresponding to a user account which is to be newly created include, for instance, a login name (user name), a face image, a nickname, a PIN, a password, an ID (HDEX ID) already used in other existing systems (e.g. program recommend service), a mail address, gender, a birth year/month, a zip code, occupation, etc. In a process of selecting a face image, a face image list, which is received from the system 20, is displayed. The user can select an arbitrary face image in the face image list as a face image corresponding to the user account that is to be newly created.

The various information items, which correspond to the user account that is to be newly created and have been input on the user account creation screen 211, are sent to the account server 21. The account server 21 checks whether the user name, PIN, etc., which correspond to the user account that is to be newly created, overlap the user names, PINs, etc. of other existing user accounts. If the account server 21 has confirmed non-overlapping, etc., the TV (TV-A) 11 displays a confirm dialog 212, based on confirm dialog screen data which is received from the system 20 (account server 21). If an “OK” button of the confirm dialog 212 has been pressed by a remote control operation by the user (an operation of a remote control unit by a user), the account server 21 creates, on the database 22, a new user account which is associated with the device account of the TV (TV-A) 11.

The process of creating a new user account and the process of editing the profile of an arbitrary user/device can also executed in State 3.

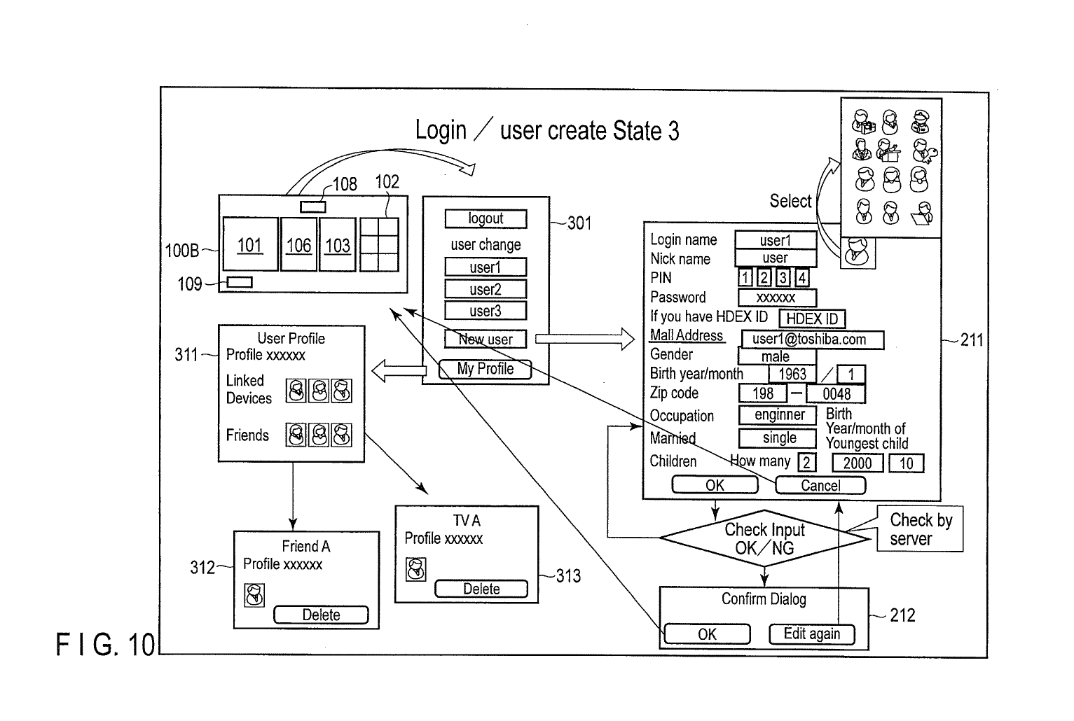

When the login/logout button 108 of the menu screen 100B has been pressed, as shown in FIG. 10, the TV (TV-A) 11 displays a logout/user change screen 301, based on logout/user change screen data which is received from the system 20. The logout/user change screen 301 displays a logout button, buttons (“user1” button, “user2” button, “user3” button) indicative of login user names to which the user is to be changed, a “New user” button, and a “My Profile” button for displaying or editing the profile of the user that is currently logging in.

If the “My Profile” button on the logout/user change screen 301 has been pressed by the user, the TV (TV-A) 11 displays a user profile screen 311, based on user profile screen data which is received from the system 20. The user profile screen 311 displays “Linked Devices” and “Friends”. The “Linked Devices” displays a list of device accounts of other devices which are linked to the user account that is currently logging in. The “Friends” displays a list of other user accounts which are linked to the user account that is currently logging in, that is, a list of friends.

If a certain user A (friend A) on the “Friends” is selected by the user of the TV (TV-A) 11, the TV (TV-A) 11 displays a profile screen 312 which enables editing of the profile of the friend A, based on profile screen data corresponding to the friend A which is received from the system 20. The profile screen 312 displays information indicative of the profile of the friend A, and also displays a “Delete” button. The “Delete” button is an operation button for deleting the friend A from the “Friends” corresponding to the user account that is currently logging in.

If a certain device (TV A) on the “Linked Devices” is selected by the user of the TV (TV-A) 11, the TV (TV-A) 11 displays a profile screen 313 which enables editing of the profile of the TV A, based on profile screen data corresponding to the TV A which is received from the system 20. The profile screen 313 displays information indicative of the profile of the TV A, and also displays a “Delete” button. The “Delete” button is an operation button for deleting the TV A from the “Linked Devices” corresponding to the user account that is currently logging in.

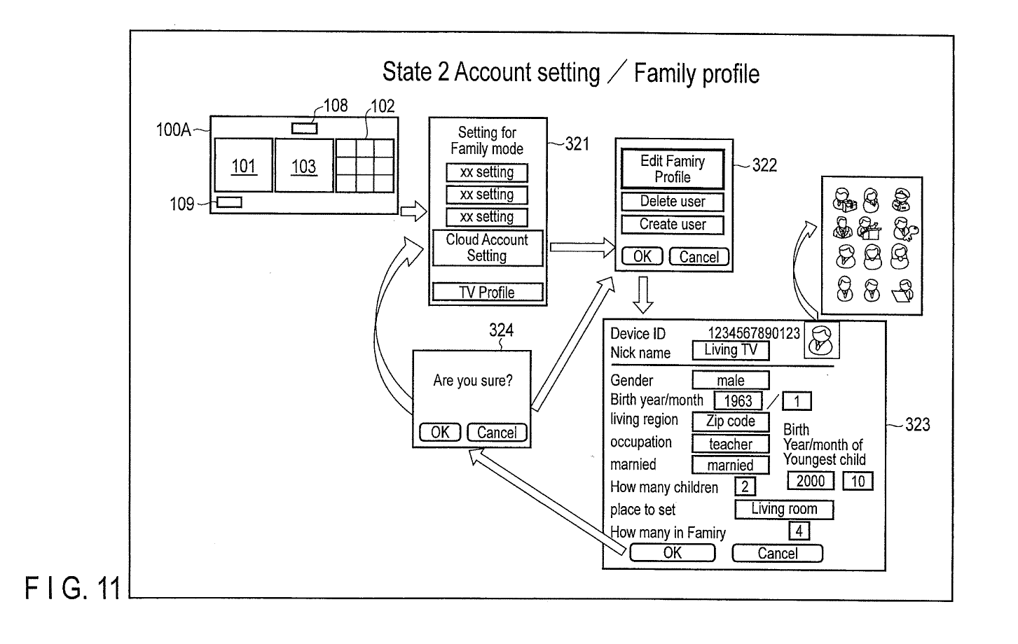

FIG. 11 illustrates a procedure of creating/editing a family profile which is the profile of the device account of the TV (TV-A) 11. If the setting button 109 on the menu screen 100A is pressed by a remote control operation by the user, the TV (TV-A) 11 displays a family mode setting screen 321, based on family mode setting screen data which is received from the system 20. The family mode setting screen 321 displays a “Cloud Account Setting” button, etc. If the “Cloud Account Setting” button is pressed, the TV (TV-A) 11 displays a cloud account setting screen 322, based on cloud account setting screen data which is received from the system 20. The cloud account setting screen 322 displays an “Edit Family Profile” button, a “Delete user” button, a “Create user” button, etc.

If the “Edit Family Profile” button is pressed by a remote control operation by the user, the TV (TV-A) 11 displays a device account creation/edit screen 323, based on device account creation/edit screen data which is received from the system 20. The case is assumed that the device account of the TV (TV-A) 11 has not yet been created, and the device account of the TV (TV-A) 11 is to be first created.

The device account creation/edit screen 323 displays the device ID of the TV (TV-A) 11, and displays a plurality of input fields for inputting various kinds of information corresponding to the device account that is to be created. The device ID of the TV (TV-A) 11 is an ID that is unique to the TV (TV-A) 11, and is prestored in the TV (TV-A) 11.

The various kinds of information corresponding to the device account that is to be created include, for instance, the nickname of the device, and the profile information of the representative of the family. The profile information of the representative of the family includes, for instance, the gender, birth year/month, zip code, and occupation.

If the “OK” button on the device account creation/edit screen 323 is pressed by a remote control operation by the user, the TV (TV-A) 11 displays a confirmation screen 324, based on confirmation screen data which is received from the system 20. If the “OK” button on the confirmation screen 324 is pressed by a remote control operation by the user, the various kinds of information, which have been input on the device account creation/edit screen 323, are transmitted to the system 20. Then, the system 20 creates the device account of the TV (TV-A) 11 on the database 22, based on the transmitted information.

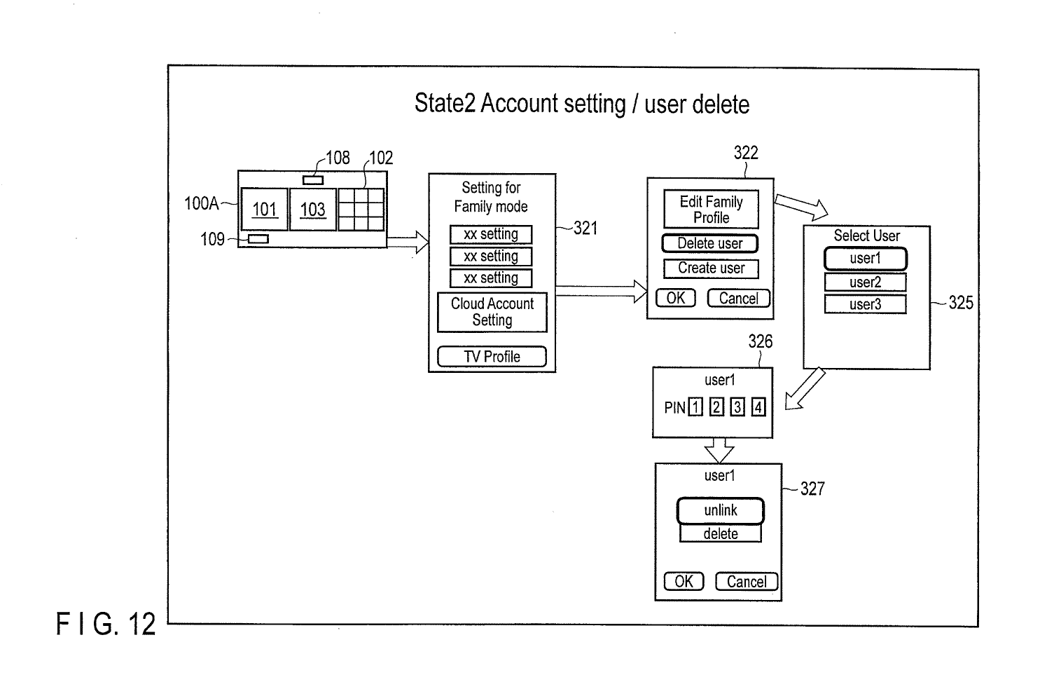

FIG. 12 illustrates a process which is executed when the “Delete user” button on the cloud account setting screen 322 has been pressed. The TV (TV-A) 11 displays a user select screen 325, based on user select screen data which is received from the system 20. The user select screen 325 displays a list of user accounts which are registered as users of the TV (TV-A) 11. If a certain user account user1 is selected by the user, the TV (TV-A) 11 displays a code input screen 326 for inputting a PIN code of user1, based on code input screen data of user1 which is received from the system 20. The account server 21 checks whether the PIN which has been input to the code input screen 326 is correct or not, that is, whether the input PIN agrees with the PIN corresponding to the selected user account. If the input PIN is correct, the TV (TV-A) 11 displays an unlink/delete select screen 327, based on unlink/delete select screen data which is received from the system 20. The unlink/delete select screen 327 displays an “Unlink” button and a “Delete” button. If the “Unlink” button is pressed, the system 20 executes a process of deleting the user account user1 from the “Attached users” of the TV (TV-A) 11. In this case, if the user account user1 has been registered as “Attached users” of another device, the user account user1 is not deleted from the “Attached users” of said another device. If the “Delete” button is pressed, the system 20 executes a process of deleting the user account user1 from the “Attached users” of all devices.

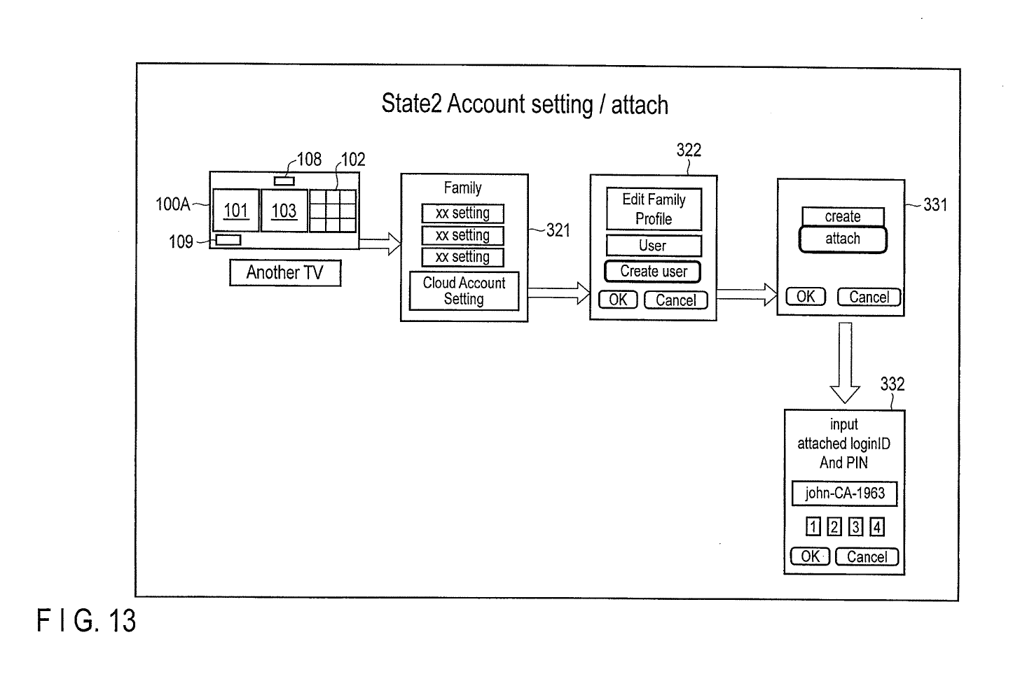

FIG. 13 illustrates a process of generating, by using information relating to an existing user account corresponding to a certain device, a new user account of another device. If the “Create user” button on the cloud account setting screen 322 is pressed by a remote control operation by the user, the TV (TV-A) 11 displays a create/attach select screen 331, based on create/attach select screen data which is received from the system 20. If an “Attach” button on the create/attach select screen 331 is pressed by a remote control operation by the user, the TV (TV-A) 11 displays, based on input screen data which is received from the system 20, an input screen 332 for inputting information relating to an existing user account which is to be used for generation of a new user account. The input screen 332 displays an input field for inputting a user name (login name) which is the identifier of the existing user account, and an input field for inputting a PIN corresponding to the existing user account. The system 20 (account server 21) checks whether the login name and PIN, which have been input to the input screen 332 by the user, are correct or not. If it is confirmed that the input login name and PIN are correct, the account server 21 registers the same user account as the above-described exiting user account as a user account of the TV that has executed the “Attach” operation.

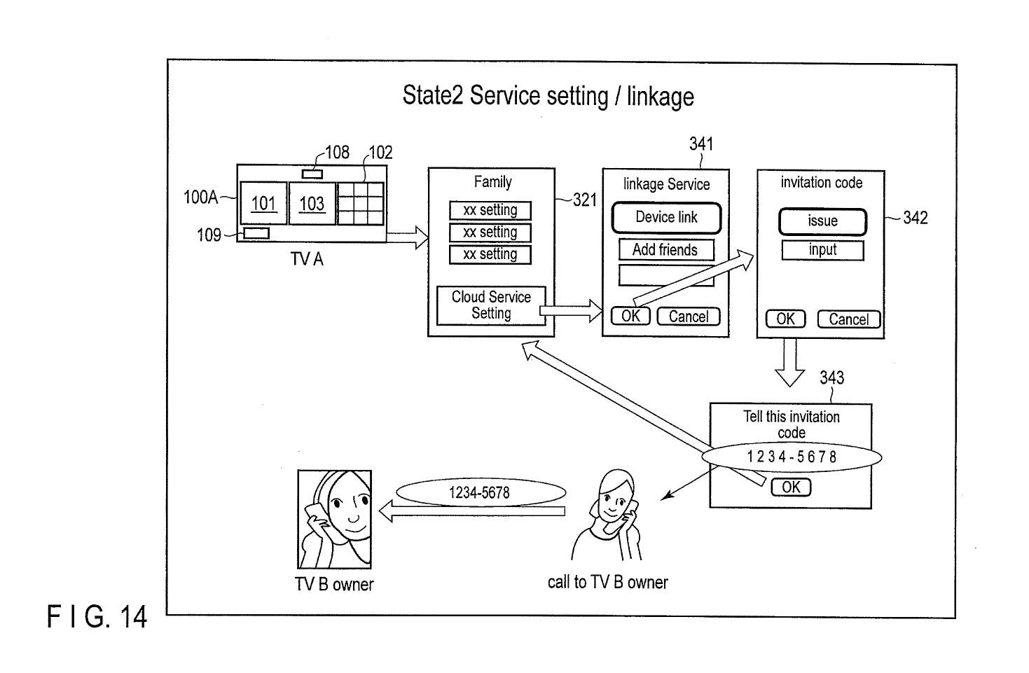

FIG. 14 illustrates a process of displaying the above-described invitation code on the TV which functions as an inviter. The case is assumed that a certain TV A functions as an inviter. If a “Cloud Service Setting” button on the family mode setting screen 321, which is displayed on the TV A, is pressed by a remote control operation by the user, the TV A displays a linkage service screen 341 on the display of the TV A, based on linkage service screen data which is received from the system 20. The linkage service screen 341 displays a “Device link” button and an “Add friend” button. The “Device link” button is a button for linking an account of another device to the account of the TV A.

If the “Device link” button is pressed by a remote control operation by the user, the TV A displays an invitation code issue/input select screen 342, based on invitation code issue/input select screen data which is received from the system 20. If an “issue” button on the invitation code issue/input select screen 342 is pressed by a remote control operation by the user, the TV A transmits an invitation code request to the system 20 (account server 21). The invitation code request may include the device ID of the TV A. The account server 21 generates an invitation code (e.g. 1234-5678) which corresponds to the TV A, and stores the generated invitation code in the state in which the generated invitation code is associated with the device account of the TV A (the device ID of the TV A). Then, the account server 21 transmits the generated invitation code to the TV A. In this case, the account server 21 may transmit code display screen data for displaying the generated invitation code to the TV A. The TV A displays a code display screen 343 on the display of the TV A, based on code display screen data which is received from the account server 21. The code display screen 343 displays the generated invitation code. By viewing the code display screen 343, the user (owner) of the TV A can learn the invitation code. For example, by making a call to the user (owner) of another TV (e.g. TV B), the user (owner) of the TV A can inform the user (owner) of the TV B of the invitation code.

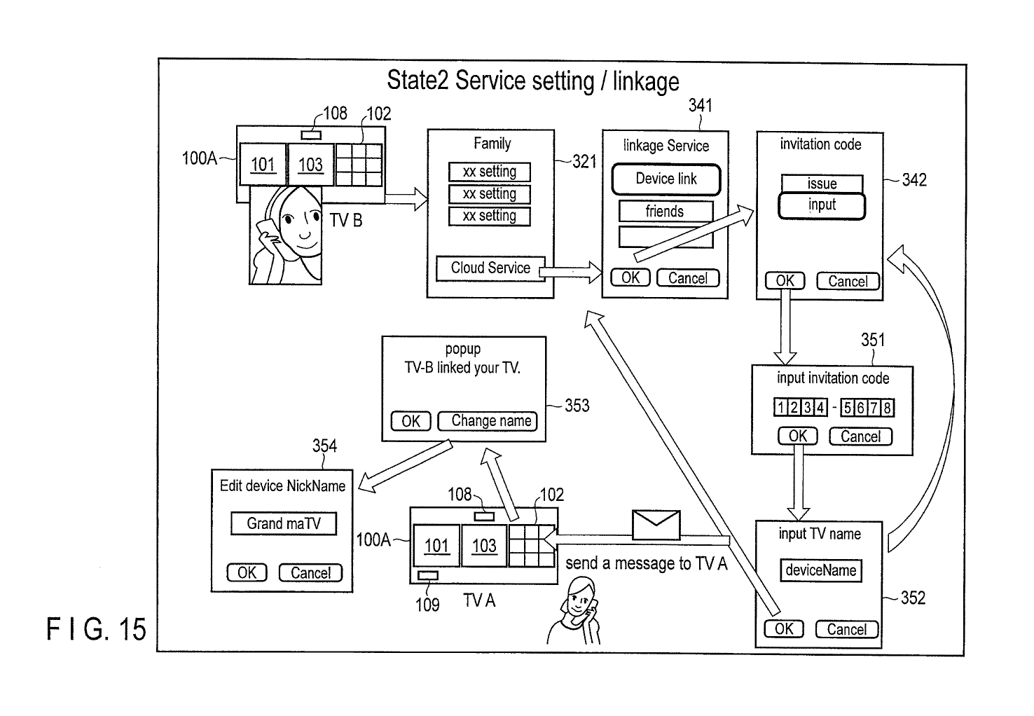

FIG. 15 illustrates a process which is executed by the TV B. For example, if an “input” button on the invitation code issue/input select screen 342, which is displayed on the display of the TV B, is pressed by a remote control operation by the user of the TV B, the TV B displays a code input screen 351 on the display of the TV B, based on code input screen data which is received from the system 20 (account server 21). This code input screen 351 is an input screen for prompting the user of the TV B to input an invitation code which is notified by the user of another TV (TV A). If an “OK” button on the code input screen 351 is pressed by a remote control operation by the user in the state in which an 8-digit invitation code is input to the code input screen 351 by the user of the TV B, the invitation code, which has been input to the code input screen 351, is transmitted to the account server 21.

Upon receiving the invitation code from the TV B, the account server 21 specifies the account (device account) of the TV, with which the received invitation code is associated. In this example, since the device account of the TV A is the device account of the TV with which the received invitation code is associated, the account server 21 links the device account of the TV A and the device account of the TV B. In this case, the account server 21 may copy the device account of the TV B, for example, to a table (linkage management table A) in the database 22 for managing the list of “Linked devices” corresponding to the device account of the TV A. In addition, the account server 21 may copy the device account of the TV A to a table (linkage management table B) in the database 22 for managing the list of “Linked devices” corresponding to the device account of the TV B. In this manner, information indicating that the TV A and TV B are mutually linked devices can be stored in the database 22.

The TV B may display, where necessary, a TV name input screen 352, and may change the name of the TV A, which is displayed on the display of the TV B, to an arbitrary name. In this case, the account server 21 transmits screen data for displaying the TV name input screen 352 to the TV B. Then, the account server 21 changes the device name (nickname) in the family profile of the device account of the TV A, which was added in the linkage management table B, to the name which has been input on the TV name input screen 352.

After the device account of the TV A and the device account of the TV B were linked, the account server 21 may generate a message including text describing that the TV B was linked to the TV A, and may transmit the generated message to the TV A. An icon corresponding to this message is displayed on the menu screen 100A of the TV A. If this icon is selected, a popup screen 353 indicative of the content of this message is displayed on the display of the TV A.

With the pressing of a “Change name” button on the popup screen 353, where necessary, the TV A can change the name of the TV B, which is displayed on the display of the TV A, to an arbitrary name. In this case, the account server 21 transmits to the TV A screen data for inputting the name of the TV B. Based on this screen data, the TV A displays an input screen 354. Then, the account server 21 changes the device name (nickname) in the family profile of the device account of the TV B, which was added in the linkage management table A, to the name which has been input on the input screen 354.

The above-described FIG. 14 and FIG. 15 illustrate the process for linking a certain device account and another device account. By the same procedure, an arbitrary device/user account can be linked to another device/user account. For example, when the “issue” button on the invitation code issue/input select screen 342 has been pressed in the state of the login by the user account User1 corresponding to the TV A, the system 20 transmits to the TV A an invitation code which is associated with the user account User1 of the TV A. Thus, in this case, this invitation code can be used for linking the user account User1 of the TV A and another device/user account.

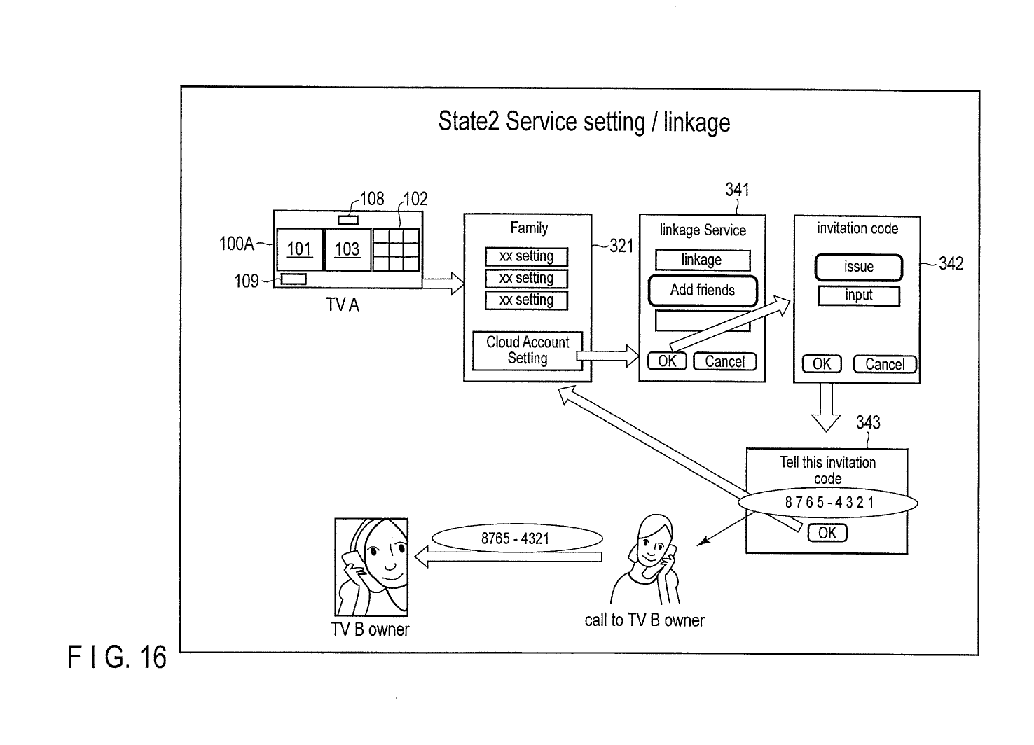

When another user account is to be added as a friend to the device account of the TV A, the “Add friend” button on the linkage service screen 341 may be pressed, as shown in FIG. 16. Then, by the same procedure as in FIG. 14, the invitation code associated with the device account of the TV A is displayed on the display of the TV A.

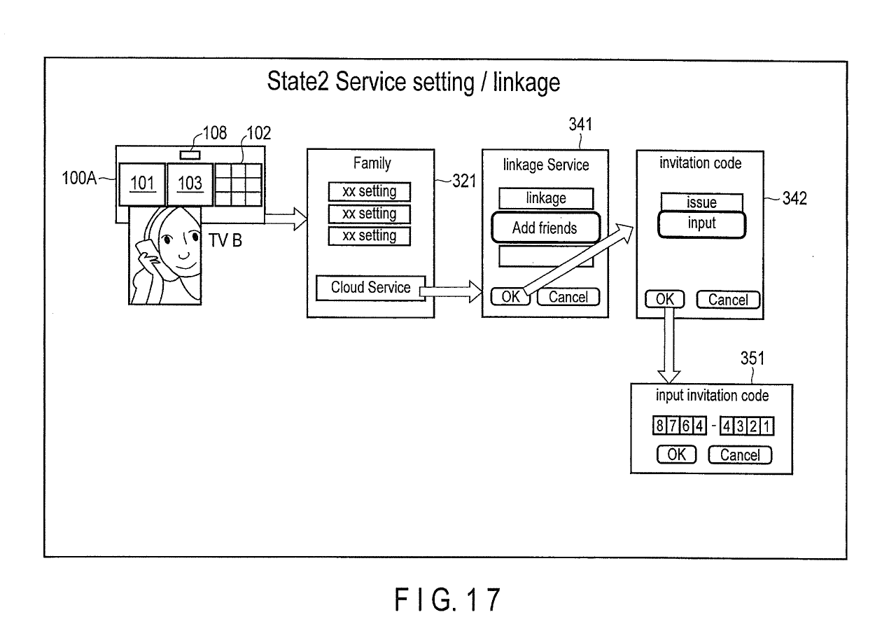

Also in the TV B, as illustrated in FIG. 17, the “Add friend” button on the linkage service screen 341 may be pressed. Then, by the same procedure as in FIG. 15, the process is executed for transmitting the invitation code, which has been input by the user of the TV B, to the account server 21.

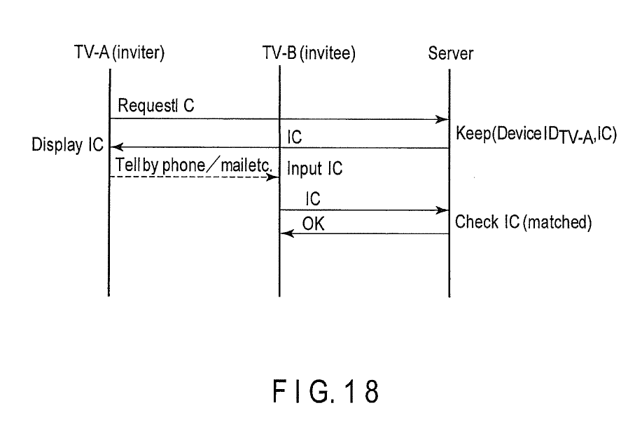

FIG. 18 illustrates the procedure of a communication process which is executed for a linkage process. The case is now assumed that the TV (TV-A) 11 functions as an inviter and the TV (TV-B) 12 functions as an invitee.

The TV (TV-A) 11 transmits an invitation code request (RequestlC) to the account server 21. The account server 21 generates an invitation code, and stores the generated invitation code in the state in which the generated invitation code is associated with the account of the TV (TV-A) 11, for instance, the device ID of the TV (TV-A) 11. Then, the account server 21 transmits the generated invitation code (IC) to the TV (TV-A) 11.

The TV (TV-A) 11 displays the invitation code (IC), which has been received from the account server 21, on the display of the TV (TV-A) 11. The TV (TV-B) 12 transmits the invitation code (IC), which has been input by the user of the TV (TV-B) 12, to the account server 21. In this case, the TV (TV-B) 12 may transmit to the account server 21 a link request including the input invitation code (IC). The account server 21 searches for an account associated with an invitation code which agrees with the invitation code (IC) received from the TV (TV-B) 12, thereby linking the account of the TV (TV-B) 12 and the account of the TV (TV-A) 11. Then, the account server 21 transmits to the TV (TV-B) 12 information indicative of the success in linkage to the TV (TV-A) 11. Needless to say, the account server 21 may further transmit to the TV (TV-A) 11 information indicative of the success in linkage to the TV (TV-B) 12.

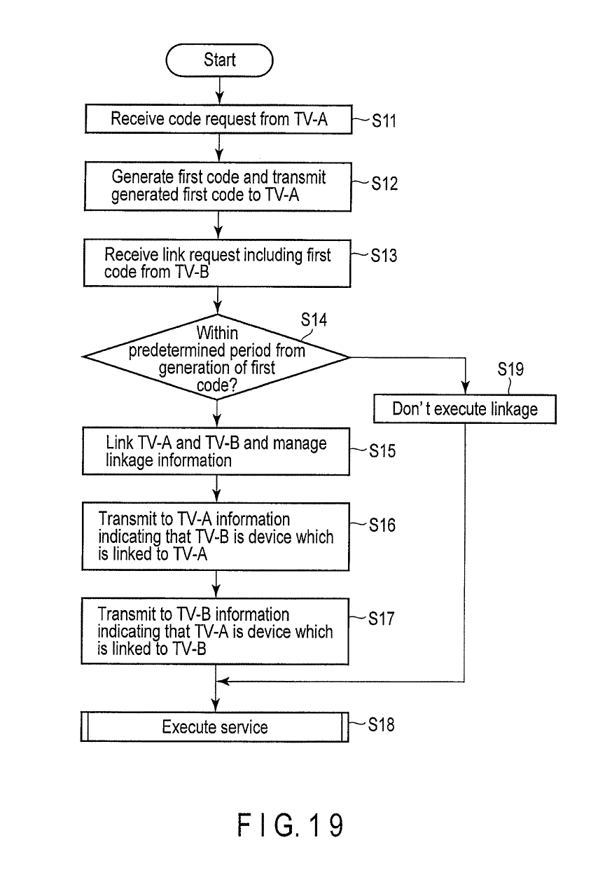

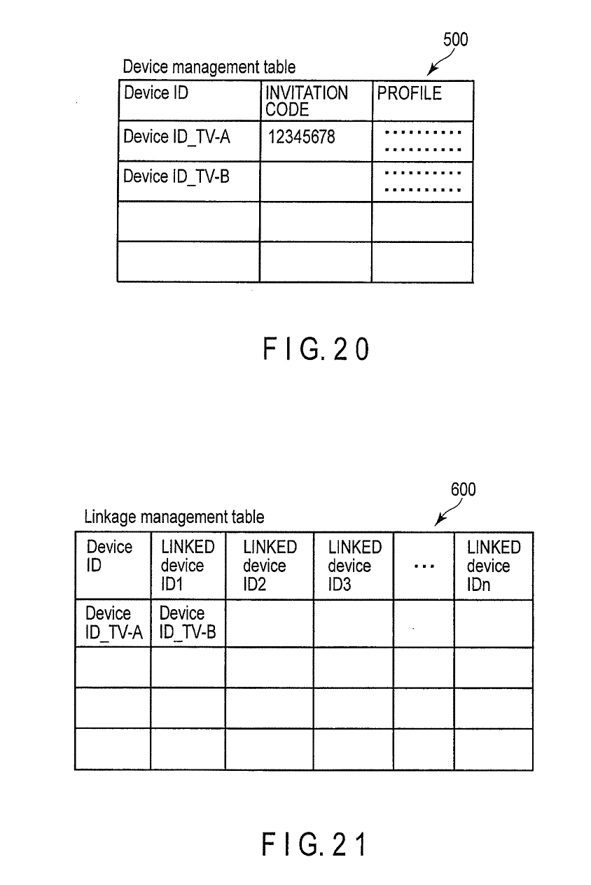

A flowchart of FIG. 19 illustrates the procedure of a linkage process which is executed by the system 20. Upon receiving a code request (invitation code request) from the TV (TV-A) 11 (step S11), the system 20 generates a first code (first invitation code) and transmits the generated first code to the TV (TV-A) 11 (step S12). In step S12, the generated first code (e.g. “12345678”) is stored in the state in which it is associated with the device account of the TV (TV-A) 11 or the user account corresponding to the TV (TV-A) 11. For example, as illustrated in FIG. 20, in the process of linking the device account of the TV (TV-A) 11 to the device account of another device or the user account of another device, the generated first code (e.g. “12345678”) is stored in a device management table 500 in the database 22 in the state in which it is associated with the device account (e.g. device ID) of the TV (TV-A) 11. On the other hand, in the process of linking the user account corresponding to the TV (TV-A) 11 to the device account of another device or the user account of another device, the generated first code (e.g. “12345678”) is stored in the state in which it is associated with the user account corresponding to the TV (TV-A) 11 in the database 22.

In the meantime, in place of the first code or in addition to the first code, first information which is generated by using the first code may be stored in the state in which it is associated with the account (device account, user account) corresponding to the TV (TV-A) 11.

If the account server 21 receives a link request including the first invitation code from the TV (TV-B) 12 (step S13), the account server 21 determines whether 48 hours or more have passed since the generation (transmission) of the first invitation code (step S14). If the link request including the first invitation code has been received within 48 hours from the generation (transmission) of the first invitation code, the account server 21 executes the following process.

The account server 21 links the device/user account of the TV (TV-A) 11 and the device/user account of the TV (TV-B) 12, and manages, with use of the database 22, information indicating that the device/user account of the TV (TV-A) 11 and the device/user account of the TV (TV-B) 12 have been linked (step S15). Specifically, in step S15, the account server 21 executes any one of a device-device link process of linking the device account of the TV (TV-A) 11 and the device account of the TV (TV-B) 12, a device-user link process of linking the user account of the TV (TV-A) 11 and the device account of the TV (TV-B) 12, a device-user link process of linking the device account of the TV (TV-A) 11 and the user account of the TV (TV-B) 12, and a user-user link process of linking the user account of the TV (TV-A) 11 and the user account of the TV (TV-B) 12.

For example, in the device-device link process of linking devices, as illustrated in FIG. 21, the device ID of the TV (TV-A) 11 and the device ID of the (TV-B) 12 are registered in a linkage management table 600.

If the device/user account of the TV (TV-A) 11 and the device/user account of the TV (TV-B) have been linked, the account server 21 invalidates the first invitation code. Thereby, the first invitation code is prohibited from being re-used by a malicious user to link another account (illicit account) and the account of the TV (TV-A) 11.

Thereafter, the account server 21 transmits to the TV (TV-A) 11 the information indicating that the TV (TV-B) 12 is the device that is linked to the TV (TV-A) 11 (step S16), and transmits to the TV (TV-B) 12 the information indicating that the TV (TV-A) 11 is the device that is linked to the TV (TV-B) 12 (step S17). Specifically, in step S16, the TV (TV-A) 11 is notified of the device/user account of the TV (TV-B) 12 that is linked to the device/user account of the TV (TV-A) 11. In step S17, the TV (TV-B) 12 is notified of the device/user account of the TV (TV-A) 11 that is linked to the device/user account of the TV (TV-B) 12. Then, the service server 31 executes a service for sharing or exchanging information between the linked accounts (step S18).

If the link request including the first invitation code has been received after the passage of 48 hours from the generation (transmission) of the first invitation code, the account server 21 does not execute linkage between the TV (TV-A) 11 and the TV (TV-B) 12 (step S19).

In the meantime, in steps S16 and S17, the transmission of the link information may be executed in response to the reception of a link request from the TV (TV-A) 11 or TV (TV-B) 12. In this case, if the account server 21 has received the link request from the TV (TV-A) 11 in the state in which the TV (TV-A) 11 is logging in to the system 20 in State 2, the account server 21 may notify the TV (TV-A) 11 of the accounts (device accounts, user accounts) of all the other devices which are associated with the device account of the TV (TV-A) 11. Similarly, if the account server 21 has received the link request from the TV (TV-A) 11 in the state in which the TV (TV-A) 11 is logging in to the system 20 in State 3 by using a certain user account User1, the account server 21 may notify the TV (TV-A) 11 of the accounts (device accounts, user accounts) of all the other devices which are associated with the user account User1 of the TV (TV-A) 11.

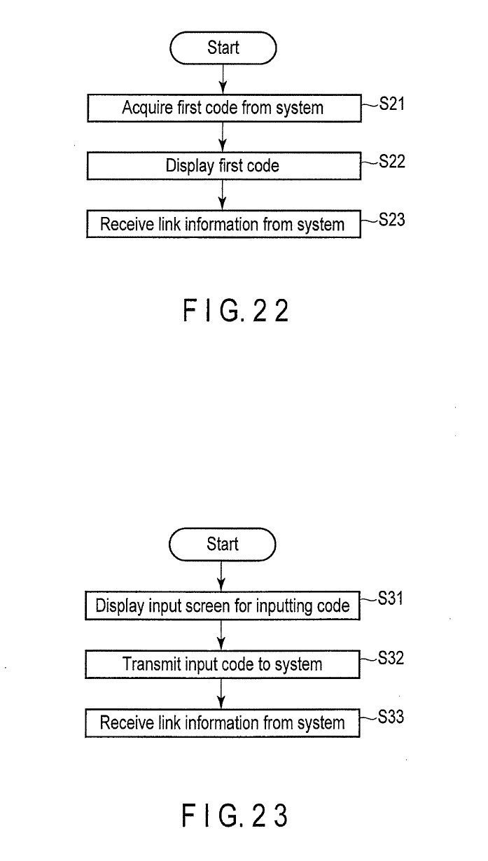

A flowchart of FIG. 22 illustrates the procedure of a process which is executed by an inviter. The TV (TV-A) 11 functioning as an inviter transmits a code request to the system 20, thereby acquiring from the system 20 a first invitation code which is associated with the account of the TV (TV-A) 11 (step S21). The TV (TV-A) 11 displays the acquired first invitation code on the display of the TV (TV-A) 11 (step S22). The user of the TV (TV-A) 11 can notify, for example, by a telephone call, the user of the TV (TV-B) 12 of the first invitation code which is displayed on the display of the TV (TV-A) 11.

Then, the TV (TV-A) 11 receives from the system 20 link information indicative of the account of another device which is linked to the account of the TV (TV-A) 11. The linkage process for linking the account of said another device and the account of the TV (TV-A) 11 is performed by the system 20, based on the first invitation code (step S23). In step S23, the TV (TV-A) 11 may transmit a link information request to the system 20.

A flowchart of FIG. 23 illustrates the procedure of a process which is executed by an invitee. The TV (TV-B) 12 functioning as an invitee displays on the display of the TV (TV-B) 12 an input screen for prompting the user to input a displayable first code (first invitation code) which is associated with the account of another electronic device (step S31). The TV (TV-B) 12 transmits the first code (first invitation code), which has been input to the input screen by the user, to the system 20 (step S32).

Then, the TV (TV-B) 12 receives from the system 20 link information indicative of the account of another device which is linked to the account of the TV (TV-B) 12 by the system 20 based on the first code (first invitation code) (step S33). In step S33, the TV (TV-B) 12 may transmit a link information request to the system 20.

As has been described above, according to the present embodiment, responding to reception of a request for a code from a first electronic device, a first code is transmitted from the system 20 to the first electronic device. The first code is a code which is associated with the account of the first electronic device and is displayable on the display of the first electronic device. Then, after first information, which is generated by using the first code, is received from a second electronic device to which the first code can be input by the user, the linkage process is executed by the system 20 for linking the account of the first electronic device and the second electronic device. Thus, it is only necessary that the user of the first electronic device informs, for example, by a telephone call, the user of the second electronic device of the first code which is displayed on the display of the first electronic device, and that the user of the second electronic device input the notified first code to the second electronic device. Thereby, the setting for exchanging or sharing information between the first electronic device and the second electronic device can be easily executed. In addition, use is made of the above-described scheme in which the first code that is displayable on the display is transmitted to the first electronic device and the first information that is generated by using the first code is received from the electronic device to which the first code can be input by the user. Thereby, the accounts of electronic devices, which can be linked to the first electronic device, can be limited to the accounts of electronic devices of acquaintances of the user of the first electronic device, and secure linkage can be realized. Incidentally, the above-described first code itself may be used as the first information which is transmitted from the electronic device to which the first code can be input by the user.

In the embodiment, use is made of not a unique device identifier such as a device ID, but a code having a less digit number than the device identifier. Thus, the code can easily be input on the input screen by, for example, the user's operation of a remote-control unit. In addition, since the code is a code with a term of validity, even if this code is stolen by a malicious third person, the damage can be minimized.

Besides, this code is invalidated if linkage is successfully carried out, even before the expiration of the term of validity. Thus, since the maximum period in which a code of a certain number is being used can be made shorter than the term of validity, many kinds of unique numbers can be generated while the digit number of the first code is kept at a small digit number.

The function of the linkage process in this embodiment can be realized by a computer program. Thus, the same advantageous effects as with the present embodiment can easily be obtained simply by installing the computer program into each electronic device and the system 20 through a computer-readable storage medium which stores the computer program, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system configured to be for providing a service for exchanging or sharing information between linked accounts, a plurality of accounts corresponding to a plurality of electronic devices, the system comprising:
a first transmitter configured to transmit a first code to a first electronic device in response to a request for a code from the first electronic device, the first code being associated with an account of the first electronic device and being displayable on a display of the first electronic device; and
a linkage module configured to link the account of the first electronic device and an account of a second electronic device to which the first code is inputtable by a user, after receiving first information generated by using the first code from the second electronic device.

2. The system of claim 1, further comprising a second transmitter configured to transmit to the first electronic device first link information indicative of the account of the second electronic device which is linked to the account of the first electronic device, and to transmit to the second electronic device second link information indicative of the account of the first electronic device which is linked to the account of the second electronic device.

3. The system of claim 1, wherein the linkage module is configured to link the account of the first electronic device and the account of the second electronic device, on condition that the first information is received from the second electronic device before passage of a first period from a time point corresponding to the transmission of the first code to the first electronic device.

4. The system of claim 1, wherein the linkage module is configured to invalidate the first code to prohibit the first code from being re-used to link another account and the account of the first electronic device, when the account of the first electronic device and the account of the second electronic device are linked.

5. The system of claim 1, wherein the first code is a code having a digit number which is less than a digit number of a device identifier of the first electronic device.

6. The system of claim 1, further comprising an account management module configured to manage a first device account of the first electronic device and one or more first user accounts corresponding to one or more users of the first electronic device, and a second device account of the second electronic device and one or more second user accounts corresponding to one or more users of the second electronic device,
wherein the first code is associated with the first device account or the first user account, and the linkage module is configured to execute any one of a device-device link process of linking the first device account and the second device account, a device-user link process of linking the first user account and the second device account, and a user-user link process of linking the first user account and the second user account.

7. An electronic device configured to be for obtaining a service for exchanging or sharing information with an account of another electronic device, comprising:
a display process module configured to display on a display an input screen for prompting a user to input a first code which is associated with the account of the another electronic device;
a transmitter configured to transmit first information, which is generated by using the first code that is input to the input screen, to a system configured to manage an account of the electronic device and the account of the another electronic device; and
a receiver configured to receive, from the system, link information indicative of the account of the another electronic device which is linked to the account of the electronic device by the system based on the first information.

8. An electronic device configured to be for obtaining a service for exchanging or sharing information with an account of another electronic device, comprising:
an acquisition module configured to transmit a code request to a system configured to manage an account of the electronic device and the account of the another electronic device, and to acquire, from the system, a first code which is associated with the account of the electronic device;
a display process module configured to display the first code on a display of the electronic device; and
a receiver configured to receive, from the system, link information indicative of an account of another electronic device which is linked to the account of the electronic device by the system based on the first code.
